(19) United States
(12) Patent Application Publication
(10) Pub. No.: US 2017/0085609 A1
(43) Pub. Date: Mar. 23, 2017

(54) EXTENDING A WEB BROWSER'S APPLICATION PROGRAM INTERFACE THROUGH NATIVE CODE

(71) Applicant: CC MEDIA NETWORK LIMITED, Tortola (VG)

(72) Inventors: Rick CLAY, Spicewood, TX (US); Bogdan DOBRAN, Cascais (PT)

(21) Appl. No.: 14/862,765

(22) Filed: Sep. 23, 2015

(51) Int. Cl. H04L 29/06; G06F 17/22; H04M 1/725; H04L 29/08; H04L 12/58

(52) U.S. Cl. CPC H04L 65/4069; H04L 67/02; H04L 51/04; H04M 1/72561; G06F 17/2247

(57) ABSTRACT

Various users may benefit from methods and devices that utilize help extend a browser's application program interface through native code in web-based applications. Certain embodiments can include launching a web-based application using a first web browser, and opening a second web browser inside the web-based application. The method can also include loading a webpages on the second web browser, where the webpage provides a link to the web-based application. The second web browser allows for greater access to an application programming interface beyond the limitations of the first web browser.

### BACKGROUND

Field

Various users may benefit from methods and devices that help extend a web browser's application program interface through native code. For example, users may benefit from enhancing any web-based application with features that are not currently exported by a standard browser.

Description of the Related Art

With the development of smart phones and tablets, web-based applications have become ubiquitous amongst mobile device users. Rather than being stored in the memory of a particular mobile device, web-based applications allow users to access content over a network each time the application is run. Web-based applications, therefore, rely on web browsers available on the device in which the application is operated. Because of the finite nature of memory, web-based applications provide users with the ability to preserve a large amount of memory that would otherwise have to be dedicated to a non-web based application.

Different web engines and web browsers usually follow a web standard, which implement features approved by World Wide Web Consortium and similar institutions. While standardization may improve compatibility between browsers, it is a very slow process which only focuses on features needed by the vast majority of users. Standardization also slows down and/or blocks the integration of many features into web browsers.

For this reason, in the past, almost all web browsers allowed plugins that were meant to integrate various functionality beyond those made available by the standard. Examples of such plugins include Java and Flash, both of which have played a major role in the evolution of the internet. The importance of plugins however has been decreased as of late. Because HyperText Markup Language 5 (HTML5), Javascript, and Cascading Style Sheets (CSS) cover, at this point in time, most of the functionality of such plugins, the need of plugins has decreased to a level where a majority of browsers have now stopped supporting such functionality. Certain embodiments of this invention fill this gap, by emulating the plugin functionality independent of which web browser is being used.

In addition, some operating systems fail to support certain desired functionalities. For instance, some operating systems fail to support various media streaming protocols. Streaming protocols can include communication rules that govern the communication of data streamed in a given logical layers. Such protocols have become of increasing importance in today's digital environment. In an attempt by vendors to promote the own streaming protocols, many devices are now sold with their own preinstalled streaming protocols. Media streaming for devices is not widely implemented in web browsers since a unified standard has yet to be developed.

As an example, Apple's iOS requires all video and audio to be streamed through Apple's HTTP Live Streaming (HLS). Users of Apple mobile products are therefore forced to stream video and audio through HLS only, without being given any alternatives—other streaming protocols are simply not supported.

### SUMMARY

According to certain embodiments, an apparatus can include at least one memory comprising computer program code and at least one processor. The at least one memory and the computer program code are configured, with the at least one processor, to cause the apparatus at least to launch a web-based application using a first web browser, and open a second web browser inside the web-based application. The at least one memory and the computer program code can also be configured, with the at least one processor, to cause the apparatus at least to load a webpage on a second web browser, where the webpage provides a link to the web-based application. The second web browser allows for greater access to an application programming interface beyond the limitations of the first web browser.

According to certain embodiments, a method can include launching a web-based application using a first web browser, opening a second web browser inside the web-based application. The method can also include loading a webpages on the second web browser, where the webpage provides a link to the web-based application. The second web browser allows for greater access to an application programming interface beyond the limitations of the first web browser.

According to certain embodiments, a non-transitory computer-readable medium encoding instructions that, when executed in hardware, perform a process. The process can include launching a web-based application using a first web browser, opening a second web browser inside a web-based application. The process can also include loading a webpages on the second web browser, where the webpage provides a link to the web-based application. The second web browser allows for greater access to an application programming interface beyond the limitations of the first web browser.

### BRIEF DESCRIPTION OF THE DRAWINGS

For proper understanding of the invention, reference should be made to the accompanying drawings,

FIG. 1 illustrates a signal flow diagram according to certain embodiments.

FIG. 2 illustrates an apparatus according to certain embodiments.

### DETAILED DESCRIPTION

Certain embodiments of the present invention allow users to enhance any web-based application with features that are not currently exported by the browser. In addition, certain embodiments allow users to bypass a standard web browser's failure to support various functionality by allowing users to import additional functionality to the web-based application.

Certain embodiments also allow a user equipment's application programming interface to move beyond the current browsers' implementation, to a level usually reserved for native applications. This allows the web-based application to experience functionality that may otherwise not be supported by the default or standard web browser of a user equipment.

A user equipment can be defined as any device capable of communicating with a web server, whether a handheld mobile device, a computer, or any other device. The user equipment may include any memory, processor, hardware, or any combination thereof. In certain embodiments of the user equipment, the processor and the memory can be configured to cause the user equipment to undergo a process.

The user equipment, in certain embodiments, may be a mobile device through which the web-based application is launched. The mobile device may run an operating software, such as iOS (for example, iOS4, iOS5, iOS6, iOS7, and iOS8 and intermediate versions and updates thereof), Android (versions 1.5 to 5.1.1), Windows operating systems (such as Windows Phone 7, Windows Phone 8, Windows 8, and Windows 10), or any other operating system compatible with mobile devices. In other embodiments, the user equipment may be a personal computer that runs any operating system compatible with personal computers.

In certain embodiments, the mobile device in which the web-based application is launched may contain a web browser. The web-based application can be compatible with any web browser, including but not limited to Internet Explorer®, Safari®, Chrome®, FireFox®, Android® Browser, Opera Mini®, and Photon®, and any version thereof. Some web browsers may not support certain functionalities that a user of a web-based application may want to implement. In addition, some web browsers do not support certain functionality provided for by the user equipment in which the web browser is running.

Certain embodiments allow a user equipment to publish a video, audio, or video/audio stream through a media streaming protocol. Media streaming protocols may include, but are not limited to, Real Time Messaging Protocol (RTMP), Real Time Streaming Protocol (RTSP), Microsoft Media Services, HTTP-based Smooth Streaming, Apple's HLS, and Shoutcast.

Some operating systems fail to support certain media streaming protocol a user may use. Meaning, that when using a given operating system, a user is limited to only using those media streaming protocols that are supported by the given operating system. As an example, Android (versions 4-5.1.1) or iOS do not support streaming video and audio through RTMP.

In certain embodiments, a user equipment may utilize any media streaming protocol, regardless of whether the user equipment's web browser or operating system supports the selected streaming protocol. In such embodiments the user equipment may bypass the limitations of the web browser and choose certain functionality not supported by the standard web browser. For instance, a user equipment may choose which media streaming protocol or protocols it prefers to utilize rather than utilizing the media streaming protocol preselected by the operating system or web browser.

For instance, in one embodiment a user equipment running version 4 of Android can utilize RTMP to stream audio and video, which creates various benefits for the user equipment that may not be available in the default streaming protocols which are compatible with Android. For instance, RTMP provides for low latency video or audio video streaming. In addition, RTMP is less restrictive than other protocols, as RTMP provides more flexibility in personalizing and controlling various features. RTMP also provides compatibility with many video streaming websites, as well as various streaming media servers, including Adobe® Flash Media Server (FMS), RED5®, and Wawza®.

In another embodiment, a web based application may involve a video game. In this embodiment, the user equipment may be able to bypass any limitations of the web browser relating to the hardware with which a user can play the video game. For instance, a joystick may be used to play the game, even though the web browser may not provide for such functionality. Importing this specific hardware functionality may require allowing a native code to be integrated into a web-based application. The native code can use the software development kit (SDK) provided by the hardware manufacturer to import native code that will allow the joystick functionality to be imported into the web-based application.

In a different embodiment, a user may enhance a web-based application by providing some user equipment power optimization functionality for specific tasks in the web-based application. A user may then import a native application into the web-based application that can be faster and more efficiency than either javascript or a standard browser application programming interface.

In certain other embodiments, a user may extend the capabilities of a web-based application, without having to wait for the standard web browser to implement support for specific hardware. One example may be a fingerprint reader. A company may release an Android device, for instance, with a built in fingerprint reader, and import a native programming language that can be integrated into a web-based application. In this embodiment, a user looking to integrate the finger print reader into a user equipment would only need to use the SDK for the device's native programming language. This would allow web-based application to support the functionality of the fingerprint reader, while keeping the user in the environment of the web-based application.

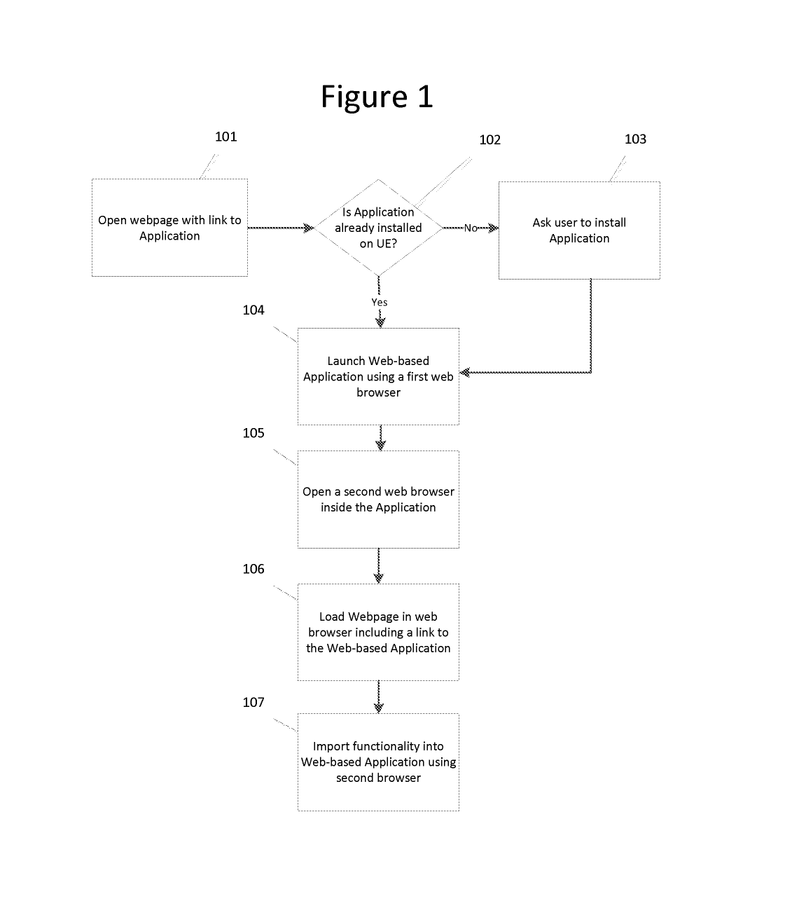

FIG. 1 illustrates a signal flow diagram representative of certain embodiments. In step 101, a user may open an internet webpage on a web browser in the user equipment that provides a link to a specific web-based application. A web-based application can be a program that is accessed over a network connection, rather than being stored in the memory of a user equipment. Although web-based applications rely on web browsers to operate, some web-based applications may restrict which web browser may be used. In addition, some web browsers may not fully support the entire functionality of the web-based application. In step 102, an inquiry can be made as to whether the web-based application is already installed on the user equipment. If not, then certain embodiments, in step 103, can be directed to an online store or an internet webpage, where the user may have the option of installing the application. In other embodiments, where the application is already installed on the user equipment, the user can directly proceed to step 104.

In step 104, the web-based application is launched using a first web browser installed on the user equipment. In certain embodiments, where the application is already installed on the user equipment, a user may launch the web-based application directly using the first web browser, without having to first undergo steps 101, 102, and/or 103. Once the web-based application is launched, then certain embodiments, in step 105, may open a new second web browser inside the web-based application. The new second web browser can allow the application to be used in a similar manner to a plugin. Meaning, that the second web browser may provide a development framework that allows users to integrate into the web-based application a specific program developed with native language outside the application.

Certain embodiments allow a user to access a user equipment's application programming interface beyond the standard browser's current implementation. For example, a user may start navigating in the Chrome web browser on his personal android device. The user may then find a webpage having a web-based application that would prefer to use a streaming protocol not supported by the operating system or the web browser. The new internal browser then launches inside the web-based application allowing a user to integrate functionality that would otherwise not be supported by the first web browser, such as a specific streaming protocol. The new second web browser is capable of preserving the user's session details in the standard browser, helping to facilitate a seamless transition.

The new second browser may still use Chrome's rendering engine, so that for the web-based application the transition may be transparent. However, the internal browser may still have the same interface features as Chrome, such as page controls, back function, forward function, and access history. In certain embodiments, the experience of the user launching the new second browser inside the web-based application may be similar to how a web video is played by Safari on an iPhone. The video player switches to full screen, replacing the browser's interface with the player's interface.

In another example, a web-based application may want to provide mobile users with a multichat video or audio experience. Although there is no current standard browser implementation for such a purpose, mostly all of the popular mobile platforms support such an experience if done through native code. Instead of having to create a native application that replaces the website and provides the multichat feature by accessing the device through native code, certain embodiments allow the web-based application to import the multichat feature directly into the web-based application, regardless of the standard browser being used to launch the web-based application. These embodiments help to integrate the wanted functionality without disrupting the web-based application experience. In addition, these embodiments do not require each website that would like to have this functionality to create its own native code application. In other words, a user can simply integrate any other website that provides the wanted functionality into their web-based application without needing any additional programming.

In step 106, a webpage may call the application with a link as a parameter, which will be loaded in the application's web browser. The link may be used for sending more information to the application, depending on the specific requirements of the application. For example, the link can be used to specify a key so that the application can only be used if the site owner has a subscription. In addition, certain embodiments may integrate a checksum mechanism or a call back mechanism, which can trigger a check to allow only licensed web-based applications to use the native code application.

In some embodiments, a javascript code can then run or be exported by the new second web browser inside the application. The javascript code further expands the functionality of the web-based application, in ways similar to the functionality offered by a HyperText Markup Language (HTML) web browser. The user interface of the web-based application can, therefore, be customized according to a user's needs through HTML. Alternatively, a user may customize the web-based application through XML. In certain embodiments, customization of the web-based application through HTML or XML can mimic that of an internet web page using a web plugin.

In other embodiments, the web-based application could export a web service that can be accessed by the web site. Alternatively, the application can communicate with the website through a separate channel, such as a WebSocket, for receiving information and executing commands.

The web-based application, in certain embodiments, may exhibit similar behavior to a standard internet webpage in a given web browser, including having a “go back” functionality. With “go back” functionality, a user can press a back button and go back to the previous webpage. Alternatively, the web-based application can also override this “go back” functionality and choose to either ignore the “go back” command, or redirect the webpage elsewhere. This functionality may be created directly in HTML, or at least controlled from HTML.

Another example of the increased functionality of the web-based application involves the use of a multichat room. Certain embodiments allow customization of a web-based application to provide for the simultaneous use of a multichat room and the application. Both the web-based application and the multichat room can load and operate together, without the web-based application restricting the user equipment to only the web-based application itself.

In step 107, therefore, certain embodiments can import functionality into the web-based application using the new web browser opened inside the application. For example, the application can use the new browser to exports a javascript object through which the web-based application can control the functionality of the application, and implement device specific features that have yet to be implemented in standard web browsers. As discussed above, some other examples of functionality that can be imported into the web-based application include accessing a specific hardware device for a video game, power optimization tools, a fingerprint reader, or any other hardware compatibility. Another example may allow a web-based application to use the functionality provided for by the user equipment, but not yet supported by the standard first web browser. For instance, the standard notification or toast in an Android system can be integrated into the web-based application.

Some embodiments may also allow a user to run media streaming protocols through the new second browser. In certain embodiments, therefore, the user may run the RTMP protocol in the application, and utilize RTMP to broadcast or stream video and audio. Streaming through RTMP can allow a user to control various related functions of the operating system which would normally not be available in the standard web browser. Allowing the user to have more control over the functionality of the application creates an environment where the web-based application can behave as close as possible to a native application developed in the native platform's programming language.

In those embodiments that utilize the RTMP protocol, the user equipment may play RTMP streams, either separately or in parallel to publishing media, revise encoding parameters, adjusting resolution, and publish video or audio to a server of choice. In addition, certain embodiments allow a web-based application to have added functionality provided by the user equipment, such as utilizing the notification method of the user equipment, and using the camera of the user equipment.

In certain embodiments, a web-based application will behave in a similar manner to a normal Android, iOS, or Windows application. These embodiments can combine the ease of customizing the interface through HTML, like any normal webpage using a web plugin, along with the extra interface options an Android, iOS, or Windows application can access. Extra interface options in Android, iOS, or Windows applications may include notification entries, toasts, bring to foreground, keep screen alive, keep wireless local area network alive, run full screen, and remove system notifications. In addition, a user can go back to the browser pages by accessing a recent applications functionality.

In certain other embodiments the webpage will continue to run in the background and allow the application to be used as a standalone application started from a browser, similar to “open in a new window” functionality on a personal computer. An example of this embodiment may include a web page that allows you to start a ‘messenger’ web app, which a user can then let run in a background, while returning to the browser.

In addition, some embodiments may utilize the FFmpeg library, meaning that certain embodiments can be based of the FFmpeg library. FFmpeg is used for decoding, encoding, transcoding, streaming and filtering. FFmpeg has the advantage of being a very mature code that may be used in many applications. Particularly, FFmpeg provides good protocol support. It also allows a user to control more video encoding parameters than other alternatives, such as Adobe Flash Player or Flash Live Media Encoder, do not provide for.|_{[A1]}

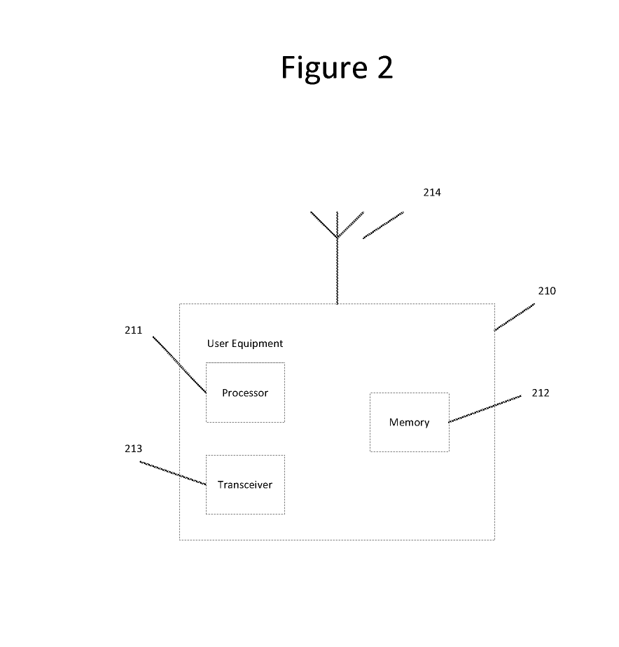

FIG. 2 illustrates a system according to certain embodiments. It should be understood that each block of the flowchart of FIG. 1 may be implemented by various means or their combinations, such as hardware, software, firmware, one or more processors and/or circuitry. In one embodiment, a user equipment 210 may include at least one processor or control unit or module, respectively indicated 211. At least one memory 212 may be provided in each user equipment. The memory may include computer program instructions or computer code contained therein. One or more transceiver 213 may be provided, and each device may also include an antenna, respectively illustrated as 214. Although only one antenna is shown, many antennas and multiple antenna elements may be provided in user equipment 210. Other configurations of user equipment, for example, may be provided.

For example, user equipment 210 may be additionally configured for wired communication, in addition to wireless communication, and in such a case antenna 214 may illustrate any form of communication hardware, without being limited to merely an antenna.

Transceiver 213 may, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner. In other words, division of labor may vary case by case. One or more functionalities may also be implemented as virtual application(s) in software that can run on a server.

A user device or user equipment 210 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof.

In some embodiment, an apparatus, such as a user device, may include means for carrying out embodiments described above in relation to FIG. 1. In certain embodiments, at least one memory including computer program code can be configured to, with the at least one processor, cause the apparatus at least to perform any of the processes described herein.

In certain embodiments, the at least one memory and a computer program code are configured to, with the at least one processor, cause the user equipment to launch a web-based application using a first web browser, and open a second web browser inside the web-based application. The at least one memory and the computer program code can also be configured, with the at least one processor, to cause the apparatus at least to load a webpage on a second web browser, where the webpage provides a link to the web-based application. The second web browser allows for greater access to an application programming interface beyond the limitations of the first web browser.

Processor 211 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memory 212 may independently be any suitable storage device, such as a non-transitory computer-readable medium. A hard disk drive (HDD), random access memory (RAM), flash memory, or other suitable memory may be used. The memory may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as UE 210, to perform any of the processes described above (see, for example, FIG. 1). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

Furthermore, although FIG. 2 illustrates user equipment 210, certain embodiments may be applicable to other configurations, and configurations involving additional elements, as illustrated and discussed herein. For example, multiple user equipment devices and multiple network nodes may be present, or other nodes providing similar functionality, such as nodes that combine the functionality of a user equipment.

According to the above embodiments, a user equipment may bypass any restriction imposed by a standard browser, and import various functionality into the web-based application. In addition, a user may customize the web-based application by using standard HTML5 to extend the functionality of the operating system. In certain embodiments where the user equipment is a mobile device, the mobile web-based application can be customized similar to how an application on a personal computer can use a flash player plugin. Some of the functionality that can be imported may include allowing access to specific hardware, providing for power optimization tools, and streaming media using any protocol preferred by the user.

The features, structures, or characteristics of certain embodiments described throughout this specification may be combined in any suitable manner in one or more embodiments. For example, the usage of the phrases “certain embodiments,” “some embodiments,” “other embodiments,” “certain other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” “in certain other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. An apparatus comprising:
at least one memory comprising computer program code;
at least one processor;
wherein the at least one memory and the computer program code are configured, with the at least one processor, to cause the apparatus at least to:
launch a web-based application using a first web browser;
open a second web browser inside the web-based application; and
load a webpage on the second web browser,
wherein the webpage provides a link to the web-based application, and
wherein the second web browser allows for greater access to an application programming interface beyond the limitations of the first web browser.

2. The apparatus according to claim 1, wherein the at least one memory and the computer program code are configured, with the at least one processor, to cause the apparatus at least to:
integrate a media streaming protocol through the webpage.

3. The apparatus according to claim 1, wherein the first web browser has not yet implemented a feature provided for by the user equipment.

4. The apparatus according to claim 1, wherein the at least one memory and the computer program code are configured, with the at least one processor, to cause the apparatus at least to:
run an operating system, wherein the operating system does not support the media streaming protocol being utilized.

5. The apparatus according to claim 4, wherein the operating system is a mobile operating system.

6. The apparatus according to claim 5, wherein the mobile operating system comprises Android version 4 or higher.

7. The apparatus according to claim 1, wherein the at least one memory and the computer program code are configured, with the at least one processor, to cause the apparatus at least to:
export a javascript object through which the functionality of the second web-based application is controlled.

8. The apparatus according to claim 1, wherein the media streaming protocol is a Real-Time Messaging Protocol.

9. The apparatus according to claim 1, wherein a program developed outside the web-based application can be integrated into the web-based application through the second web browser.

10. The apparatus according to claim 1, wherein an interface of the second web browser is customized through HyperText Markup Language (HTML).

11. The apparatus according to claim 1, wherein the at least one memory and the computer program code are configured, with the at least one processor, to cause the apparatus at least to:
ask a user to install the web-based application.

12. A method comprising:
launching a web-based application using a first web browser;
opening a second web browser inside the web-based application;
loading a webpage on the second web browser,
wherein the webpage provides a link to the web-based application, and
wherein the second web browser allows for greater access to an application programming interface beyond the limitations of the first web browser.

13. The method according to claim 12, further comprising:
integrating a media streaming protocol through the webpage.

14. The method according to claim 12, further comprising:
running an operating system, wherein the operating system does not support the media streaming protocol being utilized.

15. The method according to claim 12, further comprising:
exporting a javascript object through which the functionality of the second web-based application is controlled.

16. The method according to claim 12, wherein the media streaming protocol is a Real-Time Messaging Protocol.

17. A non-transitory computer-readable medium encoding instructions that, when executed in hardware, perform a process, the process comprising:
launching a web-based application using a first web browser;
opening a second web browser inside the web-based application;
loading a webpage on the second web browser,
wherein the webpage provides a link to the web-based application, and
wherein the second web browser allows for greater access to an application programming interface beyond the limitations of the first web browser.

18. The non-transitory computer-readable medium encoding instructions that, when executed in hardware, perform a process according to claim 17, the process further comprising:
integrating a media streaming protocol through the webpage.

19. The non-transitory computer-readable medium encoding instructions that, when executed in hardware, perform a process according to claim 17, the process further comprising:
running an operating system, wherein the operating system does not support the media streaming protocol being utilized.

20. The non-transitory computer-readable medium encoding instructions that, when executed in hardware, perform a process according to claim 17, the process further comprising:
exporting a javascript object through which the functionality of the second web-based application is controlled.
